(19) United States
(12) Patent Application Publication
(10) Pub. No.: US 2011/0209883 A1
(43) Pub. Date: Sep. 1, 2011

(54) ANIMAL SHOE

(75) Inventor: Peter Murray Griffiths, Hamilton (NZ)

(73) Assignee: SHOOF INTERNATIONAL LIMITED, Cambridge (NZ)

(21) Appl. No.: 13/128,229

(22) PCT Filed: Oct. 30, 2009
(86) PCT No.: PCT/NZ2009/000229

§ 371 Date: May 20, 2011

(30) Foreign Application Priority Data
Nov. 6, 2008 (NZ) 572617

(51) Int. Cl. A01L 9/00; A01L 11/00

(52) U.S. Cl. 168/24

(57) ABSTRACT

The present invention relates to a shoe for an animal characterised in that the material for fabrication of the show has properties similar to, or identical to a homogenous block of ethylene vinyl acetate (EVA) foam, wherein the type of EVA foam is selected from 190 EVA to 450 EVA.

### TECHNICAL FIELD

The invention relates to a shoe for an animal.

The invention has particular application for animals for cloven hooves.

### BACKGROUND ART

It is common in the animal husbandry industry to provide animals with blocks to elevate an unhealthy or damaged claw, to relieve pain and pressure on that claw, and to promote healing. This is particularly the case for dairy cow herds.

As a portion of a dairy cow's day involves traversing the concrete floors of milking sheds and roads leading to milking sheds on a daily basis, these animals experience greater lameness than hoofed animals in the wild or confined to paddocks.

Animal shoes or blocks assist in remedying physical ailments such as lameness, by being applied to the adjacent healthy claw.

Typically, animal shoes for cows are made of very durable and strong material, such as wood, leather or heavy duty plastics material. The strength of the material is particularly important as a mature dairy cow will weigh several hundred kilograms.

It is important that wear rates are consistent across the wear surface of the shoe. This would not be case if nails and the like were used as a means to fasten the shoe to the hoof of the animal as in the case of horses. Most shoes are applied to cattle using adhesive.

The materials used for conventional animal shoes, which are typically made from wood, have disadvantages. Because of their strength and durability shoes manufactured from wood do not flex. If the hoof to which the shoe is fitted is not perfectly flat, the shoe does not maintain contact across the entire surface of the hoof, leaving gaps between the shoe and the hoof.

To compensate, farmers, when fixing the shoes to the animal, may use extra adhesive as a filler for any gaps. This is wasteful of the adhesive as well as requiring further time to allow the thicker amounts of adhesive to cure. It is preferable for the cow to remain still while the adhesive cures, so it is undesirable to have lengthy curing times.

A further problem caused by the use of wooden blocks is that the shoe does not conform to the animal's natural stance. This may result in lameness or discomfort for the animal which has had its natural posture affected by the use of shoes. If the animal persists in its natural stance or gait when walking, this will result in uneven wear of the ground contact surface of the shoe.

A solution to this problem was proposed by the patentee of New Zealand Patent No. 523380. The invention in this instance is a wooden block which has a porous material applied to the hoof contact portion of the shoe. This porous material is softer than the wood, and confers a degree of conformity between the shoe and the hoof.

However, this solution has some flaws. Firstly, the construction of the shoe is more complicated due to the use of two different materials to form the shoe.

Furthermore, the adhesive layer between the porous material and the wood block is a potential source of weakness in the shoe. This is particularly the case when the shoe has been dragged or knocked against the ground. This places stress on the adhesive and may lead to the separation of the porous material from the main body of the shoe.

It is also more time consuming for the farmer fitting the shoe, as the shoe may require placing a porous material onto the shoe prior to fitting the shoe to the animal.

The shoe itself, when sold as a complete assembly (with the porous material already fixed in place), has a dedicated hoof surface side.

When fitting such shoes to cloven hoofed animals, such as cows which have left and right hoof claws, the shoes must be manufactured into left and right claw combinations. This adds extra costs to the manufacture of shoes for cloven hoofed animals.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided an animal shoe, characterised in that

the material for fabrication of the shoe has properties similar to, or identical to, a homogenous block of ethylene vinyl acetate (EVA) foam wherein the type of EVA foam is selected from 190 EVA to 450 EVA.

A preferred range is 300 to 350 EVA.

According to another aspect of the present invention there is provided a method of fixing a shoe to an animal, which includes the steps of
a) applying adhesive to a surface of an animal shoe or the hoof to which the shoe is to be applied; and
b) fixing the animal shoe to the hoof of an animal; and
c) allowing the adhesive to bond the shoe to the hoof;
   characterised by the additional step of
d) working the ground contact surface of the hoof such that the surface is substantially flat prior to fixing the shoe to the hoof.

According to another aspect of the present invention, there is provided a kitset for fitting a shoe to an animal, wherein the kitset includes:

an animal shoe; and
adhesive to bond the animal shoe to the hoof of an animal
characterised in that
the material for fabrication of the shoe has properties similar to, or identical to, a homogenous block of ethylene vinyl acetate (EVA) foam wherein the type of EVA foam is selected from 190 EVA to 450 EVA.

According to another aspect of the present invention, there is provided a kitset for fitting a shoe to an animal, wherein the kitset includes:

an animal shoe; and
adhesive to bond the animal shoe to the hoof of an animal; and
a hoof working implement.

The animal may be any hoofed animal which requires protection of its hooves from lameness. For example, the animal may be a camel or horse.

Preferably, the animal has cloven hooves.

A cloven hoof should be understood to mean a hoof with at least a left and right claw forming the hoof. The animal may be a sheep or goat, but is preferably a cow.

The shoe may be made of any material which has properties similar to or identical to a contiguous block of ethylene vinyl acetate (herein after referred to as EVA) foam.

Contiguous should be understood to mean that the foam block has the properties of comprising solely of EVA, with no additional layers of material, such as a vulcanised rubber wear surface or the like. Constructing the shoe from a single type of material greatly simplifies the overall manufacture of the animal shoe.

EVA foam is the preferred material of choice for construction of the present invention. A foam block of EVA is easily worked with a knife to better fit the shoe to the hoof of the animal.

However, persons skilled in the art will appreciate that other materials may be used to make the shoe as long as they have properties similar to, or identical to, EVA foam of the appropriate specifications.

EVA foam also allows some degree of compression when the animal places its weight upon the shoe. This allows the shoe to better conform to the hoof of the animal. By allowing the shoe to conform to the animal rather than the animal conforming to the shoe this allows the animal to maintain its natural stance and gait when walking also improves the surface area contact increasing the glued area.

Preferably, the EVA may be selected from a range of EVA foam specifications between 300 EVA to 350 EVA (according to Ultralon™ specifications).

The inventor has conducted extensive research into the most suitable EVA specifications for manufacture of animal shoes, and has found that the EVA of a specification outside of the defined range is either too soft or too hard for the animal.

EVA foam which is too soft wears too quickly, and does not provide sufficient resiliency. When the animal applies its weight to EVA foam which is too soft, the hoof is not sufficiently cushioned and “bottoms out”.

Further, EVA foam which is too soft has insufficient tensile strength to give a useful life as it tears away from the hoof.

EVA foam which is too hard does not conform to the hoof. This means that there may be some gaps between the shoe and the hoof unless it is perfectly flat. It is also less comfortable for the animal.

EVA foam which is too hard may be too jarring and uncomfortable for the animal when the animal applies its weight to the foam.

Further, using EVA foam which is too hard gives reduced bond area unless the hoof is perfectly flat.

EVA foam is preferred over other materials as it works well and is relatively inexpensive.

Preferably, the shoe includes separate blocks of EVA foam for the left and right claws of cloven hoofed animals.

Preferably shape and configuration of the shoe is the same regardless of whether the shoe is to be fitted to the left or right claws of the hoof. The present invention may be of a shape that can simply be reversed to suit the claw to which it is to be fitted.

This is possible if both faces of the shoe are the same. This can result from using a block of one material.

The adhesive used to fit the shoe to the hoof may be any type of adhesive suitable for this purpose, but is preferably cyanoacrylate adhesive. This adhesive requires no hardener additive, is compatible with the hoof and the EVA, plus cures within seconds or a few minutes (depending on the adhesive used). Persons skilled in the art will appreciate that other types of glue may be used without departing from the scope of the invention.

In some embodiments of the present invention, the hoof of the animal may need to be worked prior to fitting the shoe.

Working in this instance should be understood to mean the filing, rasping, abrading or otherwise trimming of the hoof surface using working implements such that the hoof surface is substantially flat. This is a very important step to ensure that the bonding surface between the hoof and the shoe is such that the shoe stays on the hoof (once glued) for as long as possible.

Examples of suitable working implements may be files, rasps and knives. Persons skilled in the art will appreciate that other implements may also be used for this purpose without departing from the scope of the invention.

In use, the farmer will apply adhesive to one side of the shoe (or to the hoof, or to both shoe and hoof) and fix it to the hoof of the animal. Depending on whether the shoe was placed on the left or right claw, the farmer could take another shoe, reverse it as appropriate to apply adhesive to the shoe, and fit it to the animal. Usually, however, one shoe will be used on a hoof as the other claw will be injured.

Bonding of the adhesive will be complete within a few seconds or minutes of fitting the shoe.

If necessary, the farmer may use a rasp or file to level out the ground contact surface of the hoof prior to fixing the shoe. This will allow greater conformity of the animal shoe to the hoof if necessary, and prepares the hoof surface for adequate adhesion of the shoe to the hoof.

Further, adhesive such as cyanoacrylate works best when it is applied in a thin layer. This can be achieved if the two surfaces it is bonding can be pressed flat against each other (eg, conform).

It will be appreciated that the present invention has a number of advantages over the prior art:
Greater conformity to the hoof of the animal;
Simpler to manufacture and cater for animals of varying sizes;
Simpler to fit to the animal;
Reversible to allow for left and right claws of cloven hoofed animals;
More comfortable for the animal wearing the shoe.

### BRIEF DESCRIPTION OF DRAWINGS

Further aspects of the present invention will become apparent from the following description which is given by way of example only and with reference to the accompanying drawings in which:

FIG. 1 shows a perspective view of the present invention; and

FIG. 2 shows a front view of the present invention in use.

### BEST MODES FOR CARRYING OUT THE INVENTION

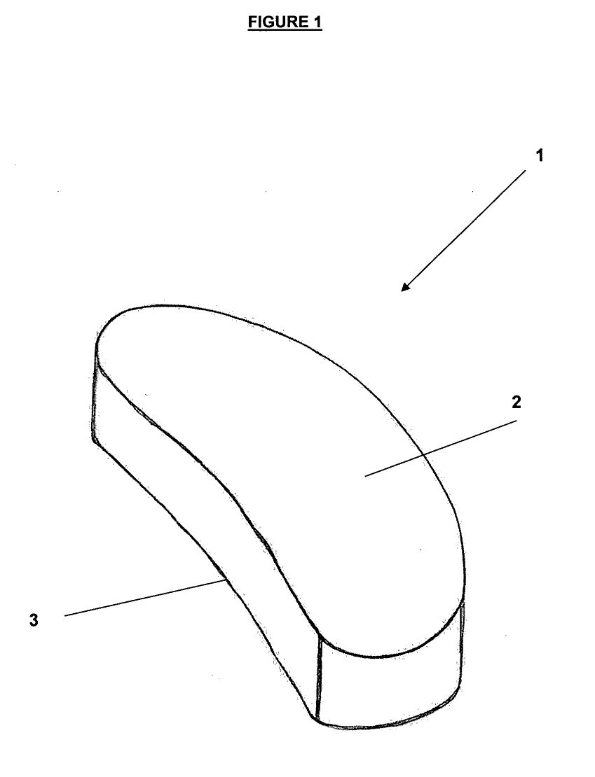

The present invention (generally indicated by arrow 1) is illustrated in FIG. 1. The shape of the shoe (1) is intended to mirror the claw of a cloven hoofed animal (not shown).

To place the shoe on the left claw of the animal, adhesive (not shown) is applied to the upper surface (2) of the shoe. This surface (2) is being held in contact with the ground contact surface of the claw (not shown).

To place the shoe (1) on the right claw of the animal (not shown) adhesive (not shown) is applied to the reverse side (3) of the shoe, which is then held in contact with the right claw (not shown).

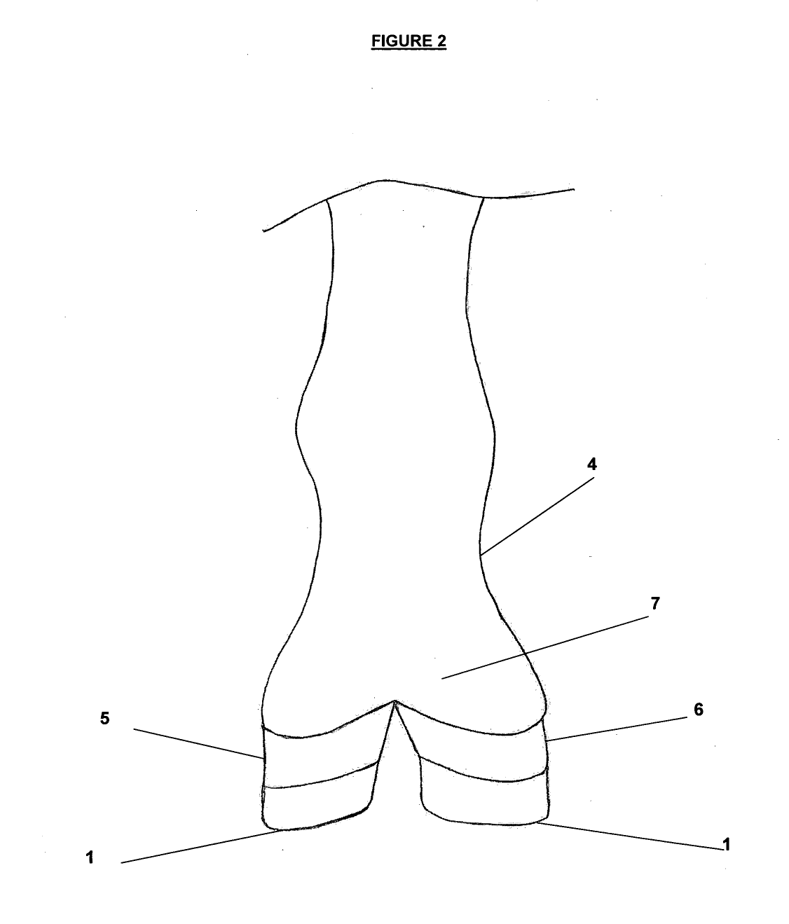

In use, as depicted in FIG. 2, the animal's foot (4) is supported by the shoe (1) which has been fitted to the left (5) and right (6) claws of the hoof (7).

Aspects of the present invention have been described by way of example only and it should be appreciated that modifications and additions may be made thereto without departing from the scope of the appended claims.

1. A shoe for an animal comprising a material formed in a shape of the shoe, said shoe material being a homogenous block of ethylene vinyl acetate (EVA) foam, wherein the type of EVA foam is selected from the group consisting of an EVA in the range 190 EVA to 450 EVA.

2. An animal shoe as claimed in claim 1 wherein the range is 300 EVA to 350 EVA.

3. An animal shoe as claimed in either claim 1, which comprises separate blocks of foam for left and right claws of an animal hoof.

4. An animal shoe as claimed in claim 3, wherein shape and configuration of the blocks are the same, regardless of whether the shoe is to be fitted to the left or right claw of the animal hoof.

5. A method of fixing a shoe as claimed in claim 1 to an animal which comprises the steps of
a) applying adhesive to a surface of an animal's shoe or a hoof to which the shoe is to be applied,
b) fixing the animal shoe to the hoof of an animal,
c) allowing the adhesive to bond the shoe to the hoof,
d) working a ground contact surface of the hoof with a hoof working implement such that the surface is substantially flat.

6. A method as claimed in claim 5, which comprises separate blocks of foam for the left and right claws of the animal hoof.

7. A method as claimed in claim 6, wherein shape and configuration of the blocks are the same, regardless of whether the shoe is to be fitted to the left or right claws of the animal hoof.

8. A method as claimed in claim 5, wherein the adhesive is cyanoacrylate.

9. A method as claimed in claim 5, wherein the ground contact surface of the hoof is worked with a rasp.

10. A kit for fitting a shoe to an animal, wherein the kit comprises:
an animal shoe according to claim 1, and
adhesive to bond the animal shoe to the hoof of the animal.

11. A kit for fitting a shoe to the animal as claimed in claim 10, wherein the range is 300 EVA to 350 EVA.

12. A kit as claimed in claim 10, which comprises separate blocks of foam for the left and right claws of the animal hoof.

13. A kit as claimed in claim 12, wherein shape and configuration of the blocks are the same regardless of whether the shoe is to be fitted to the left or right claws of the animal hoof.

14. A kit as claimed in claim 10, wherein the adhesive is cyanoacrylate.

15. A kit for fitting a shoe to the animal as claimed in claim 10, wherein the kit further comprises a hoof working implement.

16. A kit as claimed in claim 15 wherein the hoof working implement is a rasp.

17.-24. (canceled)
